(19) United States
(12) Patent Application Publication
(10) Pub. No.: US 2018/0211044 A1
(43) Pub. Date: Jul. 26, 2018

(54) METHOD AND APPARATUS FOR UPGRADING EMBEDDED MEMORY AND TERMINAL ASSOCIATED THEREWITH

(71) Applicants: BOE TECHNOLOGY GROUP CO., LTD., Beijing (CN); BEIJING BOE MULTIMEDIA TECHNOLOGY CO., LTD., Beijing (CN)

(72) Inventor: Bendeng LV, Beijing (CN)

(21) Appl. No.: 15/745,672

(22) PCT Filed: May 8, 2017
(86) PCT No.: PCT/CN2017/083421

§ 371 Date: Jan. 17, 2018

(30) Foreign Application Priority Data
May 9, 2016 (CN) 201610302814.X

(51) Int. Cl. G06F 21/57; G06F 9/30; G06F 8/65; G06F 8/71

(52) U.S. Cl. CPC G06F 21/57; G06F 8/71; G06F 8/65; G06F 9/3004

(57) ABSTRACT

Embodiments of the present disclosure provide a method and apparatus for upgrading an embedded memory and a terminal associated therewith. The method includes: reading a current embedded memory on a board card of a terminal to obtain embedded memory information; determining a machine type corresponding to the current embedded memory based on the embedded memory information; and selecting for the machine type a partition configuration file that matches with the current embedded memory to upgrade.

### CROSS-REFERENCE TO THE RELATED APPLICATIONS

The present application claims priority to Chinese patent application No. 201610302814.X, filed on May 9, 2016, the entire disclosure of which is hereby incorporated herein by reference.

### TECHNICAL FIELD

Embodiments of the present disclosure relate to the technical field of electronics, and particularly to a method and apparatus for upgrading an embedded memory and a terminal associated therewith.

### BACKGROUND

EMMC (Embedded Multi Media Card) is an embedded memory standard specification formulated by MMC (Multi Media Card) Association and mainly intended for products such as mobile phones or tablet computers, etc. With the development of technology, the standard of the EMMC specification gradually evolves into new generations.

Taking EMMC as an example, the same series of board cards may be used with different EMMCs, whereby there might be two or more types of different partitions. Such different partitions may support different EMMC system versions. For example, in current EMMC products, there exist situations where the same series of board cards include two types of partitions and can support both 4G EMMC and 16G EMMC system versions. As such, when a board card supporting two types of different system versions is subjected to a unified upgrade, a system version selection error may occur during the upgrade due to different EMMCs being used therewith. This may result in wrong upgrade for partition configuration files corresponding to EMMCs, which in turn makes it difficult for the EMMC system versions to be stably and accurately upgraded to their respective latest versions.

### SUMMARY

According to an embodiment of the present disclosure, there is provided a method for upgrading an embedded memory. The method comprises: reading a current embedded memory on a board card of a terminal to obtain embedded memory information; determining a machine type corresponding to the current embedded memory based on the embedded memory information; and selecting for the machine type a partition configuration file that matches with the current embedded memory to upgrade.

Optionally, the reading the current embedded memory on the board card of the terminal to obtain embedded memory information comprises: reading the embedded memory information of the current embedded memory from a register during initialization of the board card.

Optionally, before selecting for the machine type the partition configuration file that matches with the current embedded memory to upgrade, the method further comprises: acquiring a system version for the current embedded memory according to the machine type, so as to upgrade the partition configuration file that matches with the current embedded memory on the board card according to the system version for the current embedded memory.

Optionally, the acquiring the system version for the current embedded memory according to the machine type comprises: obtaining a download link for the system version for the current embedded memory according to the machine type; and downloading the system version for the current embedded memory from the download link.

Optionally, the download link is a download link utilizing Over the Air OTA technology.

Optionally, the embedded memory information comprises, but is not limited to, at least one of the following: the size of the current embedded memory, the specification that the current embedded memory complies with, and the model of the current embedded memory.

Optionally, the system version corresponding to the partition configuration file includes, but is not limited to, 4G embedded memory version and 16G embedded memory version.

According to an embodiment of the present disclosure, there is provided an apparatus for upgrading an embedded memory. The apparatus comprises a reader module, a determiner module and a selector module. The reader module is connected with a board card of a terminal, and is configured to read a current embedded memory on the board card to obtain embedded memory information. The determiner module is connected with the reader module, and is configured to determine a machine type corresponding to the current embedded memory based on the embedded memory information read by the reader module. The selector module is connected with the board card and the determiner module, and is configured to select for the machine type determined by the determiner module a partition configuration file that matches with the current embedded memory on the board card to upgrade.

Optionally, the reader module is connected with a register on the board card and is configured to read the embedded memory information of the current embedded memory from the register during initialization of the board card.

Optionally, the apparatus further comprises: an acquirer circuit connected with the determiner module. The acquirer circuit is configured to acquire a system version for the current embedded memory according to the machine type determined by the determiner module, so as to upgrade the partition configuration file that matches with the current embedded memory on the board card according to the system version for the current embedded memory.

Optionally, the acquirer circuit comprises: a link sub-circuit and a download sub-circuit. The link sub-circuit is configured to obtain a download link for the system version for the current embedded memory according to the machine type. The download sub-circuit is connected with the link sub-circuit, and is configured to download the system version for the current embedded memory from the download link obtained by the link sub-circuit.

Optionally, the download link is a download link utilizing Over the Air OTA technology.

Optionally, the embedded memory information comprises, but is not limited to, at least one of the following: the size of the current embedded memory, the specification that the current embedded memory complies with, and the model of the current embedded memory.

Optionally, the system version corresponding to the partition configuration file includes, but is not limited to, 4G embedded memory version and 16G embedded memory version.

Optionally, the reader module is a reading circuit. The determiner module is a comparator. The selector module is a transmission link establishing circuit. The reading circuit is connected to the board card through an embedded memory interface at one end, and is connected with the comparator at the other end. The reading circuit is configured to read the current embedded memory on the board card to obtain embedded memory information and may for example buffer it to a buffer chip. The comparator is connected with the reading circuit at one end and is connected with the transmission link establishing circuit at the other end. The comparator is configured to receive the embedded memory information buffered by the buffer chip in reading circuit, determine the machine type corresponding to the current embedded memory, and transmit a determination result to the transmission link establishing circuit. According to the determination result, the transmission link establishing circuit establishes a corresponding transmission link to connect the board card of the terminal with an upgrade file memory, and receive the system version for the current embedded memory from the upgrade file memory for updating the partition configuration file that matches with the current embedded memory. Each of the transmission links corresponds to one of partitions of the board card. The transmission link establishing circuit is configured to, according to the determination result, control to establish a transmission link corresponding to the partition that supports the current embedded memory version, and transmit the system version for the current embedded memory in the upgrade file memory to the board card of the terminal for upgrading the partition configuration file that matches with the current embedded memory.

Optionally, the embedded memory may be any one of Embedded Multi Media Card EMMC, Universal Flash Storage UFS and Non-Volatile Memory express NVMe.

According to an embodiment of the present disclosure, there is provided a terminal including any one of the aforesaid apparatuses for upgrading an embedded memory.

### BRIEF DESCRIPTION OF DRAWINGS

To accomplishment of the foregoing and related ends, the following description and annexed drawings set forth certain illustrative aspects and implementations. These are indicative of but a few of the various ways in which one or more aspects may be employed. Other aspects, advantages, and novel features of embodiments of the disclosure will become apparent from the following detailed description when considered in conjunction with the annexed drawings.

FIG. 1 is a structural schematic diagram of an apparatus for upgrading an embedded memory according to an embodiment of the present disclosure;

FIG. 2 is a structural schematic diagram of an apparatus for upgrading an embedded memory according to another embodiment of the present disclosure;

FIG. 3 is a structural schematic diagram of an apparatus for upgrading an embedded memory according to a further embodiment of the present disclosure;

FIG. 4 is a flow chart of a method for upgrading an embedded memory according to an embodiment of the present disclosure;

FIG. 5 is a flow chart of a method for upgrading an embedded memory according to another embodiment of the present disclosure; and

FIG. 6 is a structural schematic diagram of a terminal according to an embodiment of the present disclosure.

### DETAILED DESCRIPTION

In the following description, certain specific details of the disclosed embodiment such as architecture, interfaces and techniques, etc., are set forth for purposes of explanation rather than limitation, so as to provide a clear and thorough understanding of the present invention. However, it should be understood readily by those skilled in the art that the present disclosure may be practiced in other embodiments which do not conform exactly to the details set forth herein, without departing significantly from the spirit and scope of this disclosure. Further, in this context, and for the purpose of brevity and clarity, detailed descriptions of well-known apparatus, circuits and methodology have been omitted so as to avoid unnecessary detail and possible confusion.

According to embodiments of the present disclosure, when embedded memories on a board card of a terminal are upgraded, matching partition configuration files are selected to upgrade for various machine types based on embedded memory information. This enables to perform unified upgrade for different embedded memory versions supported by the same board card, thus avoiding wrong upgrade of partition configuration files corresponding to embedded memories, which may occur during the upgrade due to a system version selection error. Thereby, it ensures that individual versions can be stably and accurately upgraded to their respective latest versions.

According to embodiments of the present disclosure, an embedded memory may be used in a terminal such as a mobile phone or tablet computer to serve as a storage device. In use, the embedded memory may be mounted on a board card of a terminal. The board card may generally support different embedded memory versions, and each of the embedded memory versions has its respective partition configuration file. When the embedded memory versions are upgraded or a single system upgrade package is to be used for a plurality of machine types, it is required to upgrade/update respective partition configuration files.

According to embodiments of the present disclosure, an embedded memory may comprise EMMC, UFS, NVMe and the like.

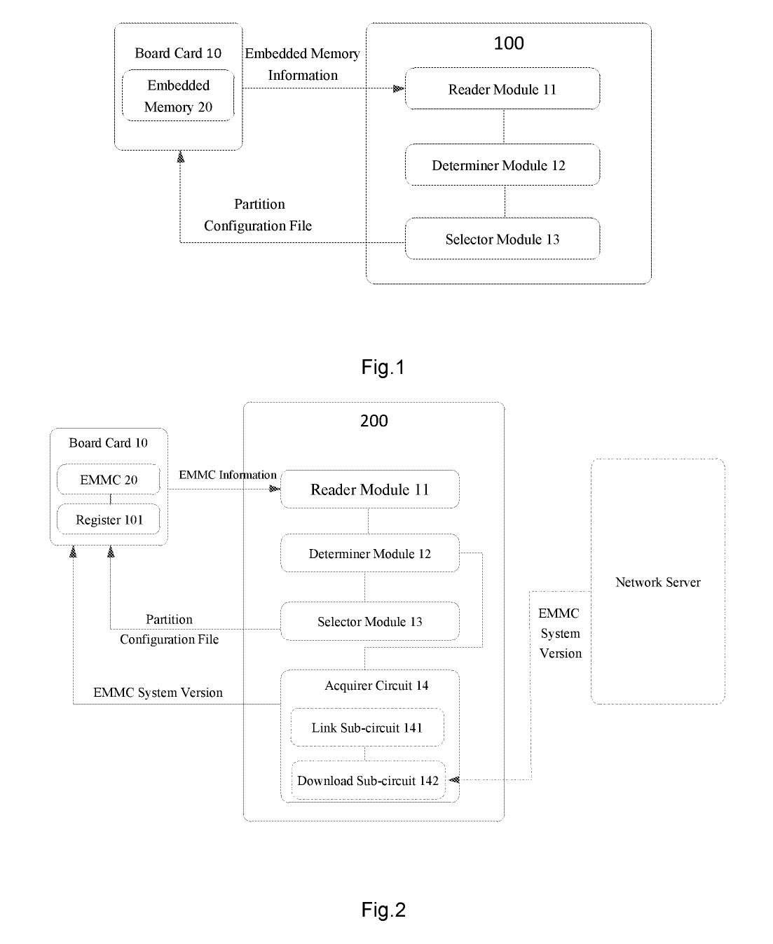

FIG. 1 shows an apparatus 100 for upgrading an embedded memory according to an embodiment of the present disclosure. As shown in FIG. 1, the apparatus 100 comprises a reader module 11, a determiner module 12 and a selector module 13.

The reader module 11 is connected with a board card 10 of a terminal, and is configured to read a current embedded memory 20 of the board card 10 to obtain embedded memory information. In some embodiments, the embedded memory information may be information describing characteristics of the embedded memory. Exemplarily, the embedded memory information may comprise, but is not limited to, any one of the following: the size of the current embedded memory, the specification that the current embedded memory complies with, and the model of the current embedded memory. The size of the embedded memory may be indicated by its capacity, for example 4 GB or 16 GB, etc. The specification that the embedded memory complies with may be indicated by a release of a specification formulated by a standardization organization such as JEDEC (e.g., EMMC 5.0, EMMC 5.1 or UFS 2.0, UFS 2.1), pin specification (e.g., FBGA153, FBGA169, FBGA162 and FBGA186) and the like. Models of embedded memories may be respective identification codes defined by different manufacturers according to characteristics, such as performance and specification, etc., of the embedded memories.

The determiner module 12 is connected with the reader module 11 and is configured to determine a machine type corresponding to the current embedded memory based on the embedded memory information read by the reader module 11. In some embodiments, the machine type corresponding to the current embedded memory may be determined based on the size of the embedded memory, the specification that the embedded memory complies with and/or the model of the embedded memory.

The selector module 13 is connected with the board card 10 and the determiner module 12, and is configured to select a partition configuration file that matches with the current embedded memory on the board card 10 to upgrade according to the machine type determined by the determining model 12.

Exemplarily, when the embedded memory is an EMMC, the EMMC system versions that correspond to the partition configuration files include, but are not limited to, 4G EMMC version and 16G EMMC version.

By the apparatus for upgrading an embedded memory according to embodiments of the present disclosure, the current embedded memory on the board card can be read to obtain the embedded memory information. The machine type corresponding to the current embedded memory is determined based on the embedded memory information. A partition configuration file that matches with the current embedded memory is selected to upgrade according to the machine type. Since selection of a partition configuration file that matches with the current embedded memory is performed based on the embedded memory information of the embedded memory before the upgrade, the upgrade is enabled to accurately match with the partition configuration file to be upgraded. Therefore, it allows a unified upgrade for different embedded memory versions supported by the same board card, thereby avoiding wrong upgrade of partition configuration files corresponding to embedded memories, which may occur during the upgrade due to a system version selection error. This ensures that individual versions can be stably and accurately upgraded to their respective latest versions.

FIG. 2 illustrates a structural schematic diagram of an apparatus 200 for upgrading an embedded memory according to another embodiment of the present disclosure by taking EMMC as an example. Referring to FIG. 2, the reader module 11 is connected with a register 101 on a board card 10 and is configured to read EMMC information of a current EMMC 20 from the register 101 during initialization of the board card 10.

The apparatus 200 further comprises: an acquirer circuit 14 connected with the determiner module 12. The acquirer circuit 14 is configured to acquire a system version for the current EMMC according to the machine type determined by the determiner module 12, for upgrading a partition configuration file that matches with the current EMMC on the board card according to the system version for the current EMMC.

With the above approach, acquisition of an EMMC system version is achieved, so that the partition configuration file that matches with the current EMMC may be upgraded according to the EMMC system version after the partition configuration file that matches with the current EMMC is located.

In an example, the acquirer circuit 14 comprises: a link sub-circuit 141 and a download sub-circuit 142. The link sub-circuit 141 is configured to obtain a download link for the system version for the current EMMC according to the machine type. The download sub-circuit 142 is connected with the link sub-circuit 141 and is configured to download the system version for the current EMMC from the download link obtained by the link sub-circuit 141. The above approach provides a solution for automatically downloading the system version for the current EMMC from a network server according to a link, such as a URL on the Internet. To improve efficiency of the downloading, the download link may be a download link utilizing Over the Air OTA technology.

According to an embodiment of the present disclosure, modules or sub-circuits comprised in the apparatus for upgrading an embedded memory may be implemented via stand-alone processor and/or controller individually, or may be collectively integrated into a single processor in the apparatus for upgrading. In addition, these modules or sub-circuits may also be stored in a computer-readable storage medium in a form of program code, which may be invoked by a processor of the apparatus for upgrading to perform the described functions. In addition, the processor described herein may be a central processing unit (CPU), or an application specific integrated circuit (ASIC), or one or more integrated circuits that are configured to implement embodiments of the present disclosure.

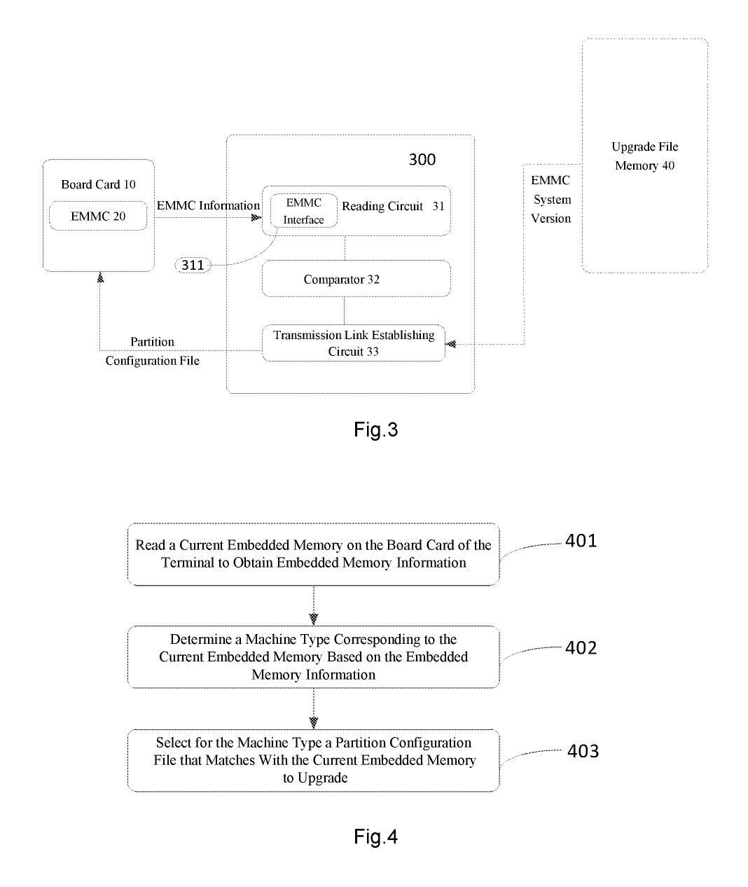

FIG. 3 shows a structural schematic diagram of an apparatus 300 for upgrading an embedded memory according to a further embodiment of the present disclosure by taking EMMC as an example. As shown in FIG. 3, the reader module is implemented as a reading circuit 31, the determiner module is implemented as a comparator 32 and the selector module is implemented as a transmission link establishing circuit 33. The reading circuit 31 is connected to a board card 10 through an EMMC interface 311 at one end, and is connected with the comparator 32 at the other end. The reading circuit 31 is configured to read the current EMMC 20 on the board card 10 to obtain EMMC information and buffer it into e.g., a buffer chip. The comparator 32 is connected with the reading circuit 31 at one end and connected with the transmission link establishing circuit 33 at the other end. The comparator 32 is configured to receive the EMMC information obtained by the reading circuit, e.g., retrieve the buffered information from the buffer chip, determine the machine type corresponding to the current EMMC, and transmit a determination result to the transmission link establishing circuit 33. In some embodiments, the comparator 32 compares the obtained EMMC information with corresponding information in a stored lookup table for machine type, so as to determine the machine type corresponding to the current EMMC. The transmission link establishing circuit 33 may establish a corresponding transmission link according to the determination result to connect the board card 10 of the terminal with an upgrade file memory 40, and receive the system version for the current EMMC from the upgrade file memory 40 for upgrading a partition configuration file that matches with the current EMMC. In some embodiments, there may be a plurality of transmission links, each corresponding to one of partitions of the board card. The transmission link establishing circuit 33 may control to establish a transmission link corresponding to the partition that supports the current EMMC version according to the determination result, and transmit the system version for the current EMMC in the upgrade file memory 40 to the board card 10 of the terminal for upgrading the partition configuration file that matches with the current EMMC. The upgrade file memory 40 may be either a local memory or an online server.

FIG. 4 shows a flow chart of a method for upgrading an embedded memory according to an embodiment of the present disclosure. Referring to FIG. 4, an embodiment of the present disclosure provides a method for upgrading an embedded memory. The method comprises the following steps:

401: Reading a current embedded memory on a board card of a terminal to obtain embedded memory information. Optionally, the embedded memory information may comprise, but not limited to, at least one of the following: the size of the current embedded memory, the specification that the current embedded memory complies with, and the model of the current embedded memory.

402: Determining a machine type corresponding to the current embedded memory based on the embedded memory information.

403: Selecting for the machine type a partition configuration file that matches with the current embedded memory to upgrade.

The board card may include more than two partition configuration files matching with respective embedded memories. The partition configuration files are generally distinguished by their sizes, and partition configuration files with different sizes may support different system versions. Taking EMMC as an example, for instance, a 4G partition code block supports 4G EMMC version, and a 16G partition code block supports 16G EMMC version, and so on. Before upgrade, the current embedded memory on the board card is firstly read to obtain the embedded memory information. The machine type corresponding to the current embedded memory is then determined based on the embedded memory information. A partition configuration file that matches with the current embedded memory is selected for the machine type to upgrade. Since selection of a partition configuration file that matches with the current embedded memory is performed based on the embedded memory information of the embedded memory before the upgrade, the upgrade is enabled to accurately match with the partition configuration file to be upgraded. Therefore, it allows a unified upgrade for different embedded memory versions supported by the same board card, thereby avoiding wrong upgrade of partition configuration files corresponding to the embedded memories, which may occur during the upgrade due to a system version selection error. This ensures that individual versions can be stably and accurately upgraded to their respective latest versions.

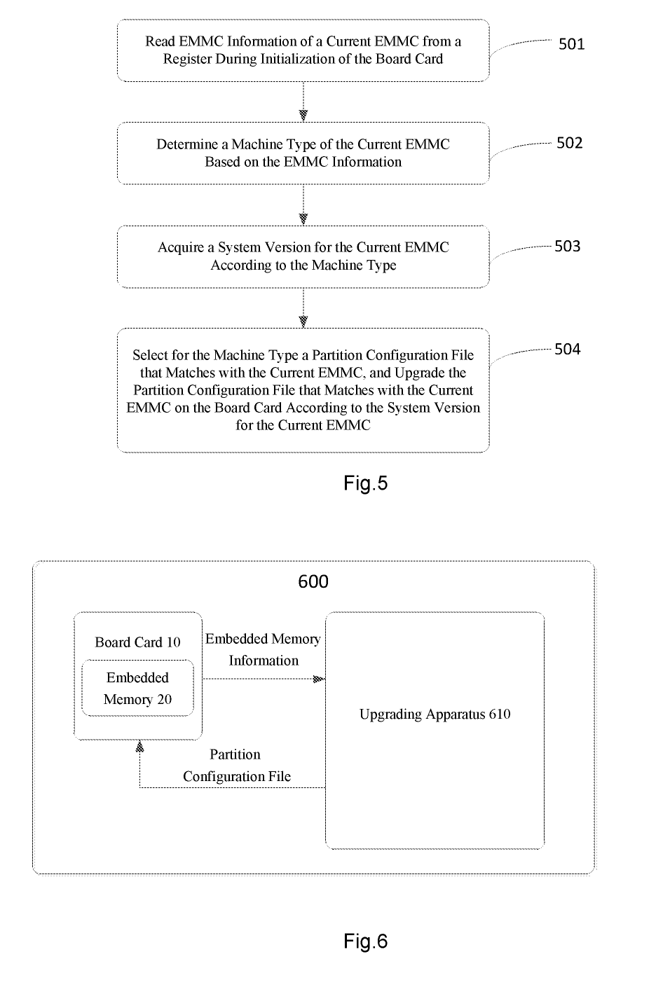

FIG. 5 shows a flow chart of a method for upgrading an embedded memory according to an embodiment of the present disclosure by taking

EMMC as an example. Referring to FIG. 5, an embodiment of the present disclosure provides a method for upgrading an EMMC. The method comprises the following steps:

501: Reading EMMC information of a current EMMC from a register during initialization of a board card. Optionally, the EMMC information may comprise, but not limited to, at least one of the following: the size of the current EMMC, the specification that the current EMMC complies with, and the model of the current EMMC.

502: Determining a machine type corresponding to the current EMMC based on the EMMC information.

503: Acquiring a system version for the current EMMC according to the machine type. Exemplarily, a download link for the system version for the current EMMC may be acquired according to the machine type; and the system version for the current EMMC may be downloaded from the download link. In an example, the download link may be a download link utilizing Over the Air OTA technology.

504: Selecting a partition configuration file that matches with the current EMMC for the machine type, and upgrading the partition configuration file that matches with the current EMMC on the board card according to the system version for the current EMMC. In some embodiments, the system version corresponding to the partition configuration file may include, but not limited to, 4G EMMC version and 16G EMMC version.

It should be noted that embodiments of the present disclosure are described by taking EMMC as an example in some of drawings for ease of illustration. Those skilled in the art would understand that these depictions are also applicable to other types of embedded memories, such as UFS, NVMe, and so on.

FIG. 6 shows a structural schematic diagram of a terminal 600 according to an embodiment of the present disclosure. As shown in FIG. 6, the terminal 600 comprises a board card 10 and an upgrading apparatus 610 for upgrading an embedded memory according to an embodiment of the present disclosure, for example, the apparatus 100 illustrated with reference to FIG. 1 and the apparatus 200 illustrated with reference to FIG. 2. The upgrading apparatus 610 upgrades the embedded memory by selecting a partition configuration file that matches with the current embedded memory 20 on the board card 10 to upgrade.

According to embodiments of the present disclosure, since selection of a partition configuration file that matches with the current embedded memory is performed based on the embedded memory information of the embedded memory before the upgrade, the upgrade is enabled to accurately match with the partition configuration file to be upgraded. Therefore, it allows a unified upgrade for different embedded memory versions supported by the same board card, thereby avoiding wrong upgrades of the partition configuration files corresponding to embedded memories, which may occur during the upgrade due to a system version selection error. This ensures that individual versions can be stably and accurately upgraded to their respective latest versions.

Although embodiments of the disclosure have been shown and described with respect to one or more implementations, equivalent alterations and modifications will occur to others skilled in the art based upon a reading and understanding of this specification and the annexed drawings, without departing form the spirit of the technical solutions of the present disclosure. The alterations and modifications all fall within the scope of technical solutions recited in the present disclosure. Embodiments of the present disclosure include all such modifications and alterations and are limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application.

1. A method for upgrading an embedded memory, comprising:
reading a current embedded memory on a board card of a terminal to obtain embedded memory information;
determining a machine type corresponding to the current embedded memory based on the embedded memory information; and
selecting for the machine type a partition configuration file that matches with the current embedded memory to upgrade.

2. The method according to claim 1, wherein said reading the current embedded memory on the board card to obtain embedded memory information comprises:
reading the embedded memory information of the current embedded memory from a register during initialization of the board card.

3. The method according to claim 1, wherein, before selecting for the machine type the partition configuration file that matches with the current embedded memory to upgrade, the method further comprises:
acquiring a system version for the current embedded memory according to the machine type, for upgrading the partition configuration file that matches with the current embedded memory on the board card according to the system version for the current embedded memory.

4. The method according to claim 3, wherein said acquiring the system version for the current embedded memory according to the machine type comprises:
obtaining a download link for the system version for the current embedded memory according to the machine type; and
downloading the system version for the current embedded memory from the download link.

5. The method according to claim 4, wherein the download link is a download link utilizing Over the Air OTA technology.

6. The method according to claim 1, wherein the embedded memory information comprises at least one of the following: the size of the current embedded memory, the specification that the current embedded memory complies with, and the model of the current embedded memory.

7. The method according to claim 1, wherein the system version for embedded memory corresponding to the partition configuration file includes 4G EMMC version and 16G EMMC version.

8. The method according to claim 1, wherein the embedded memory is any of Embedded Multi Media Card EMMC, Universal Flash Storage UFS and Non-Volatile Memory express NVMe.

9. An apparatus for upgrading an embedded memory, comprising:
a reader module connected with a board card of a terminal, and is configured to read a current embedded memory on the board card to obtain embedded memory information;
a determiner module connected with the reader module, and is configured to determine a machine type corresponding to the current embedded memory based on the embedded memory information read by the reader module; and
a selector module connected with the board card and the determiner module, and is configured to select for the machine type determined by the determiner module a partition configuration file that matches with the current embedded memory on the board card to upgrade.

10. The apparatus according to claim 9, wherein the reader module is connected with a register on the board card and is configured to read the embedded memory information of the current embedded memory from the register during initialization of the board card.

11. The apparatus according to claim 9, further comprises: an acquirer circuit connected with the determiner module, and configured to acquire a system version for the current embedded memory according to the machine type determined by the determiner module, for upgrading the partition configuration file that matches with the current embedded memory on the board card according to the system version for the current embedded memory.

12. The apparatus according to claim 11, wherein the acquirer circuit comprises:
a link sub-circuit configured to obtain a download link for the system version for the current embedded memory according to the machine type; and
a download sub-circuit connected with the link sub-circuit, and configured to download the system version for the current embedded memory from the download link obtained by the link sub-circuit.

13. The apparatus according to claim 12, wherein the download link is a download link utilizing Over the Air OTA technology.

14. The apparatus according to claim 9, wherein the embedded memory information comprises at least one of the following: the size of the current embedded memory, the specification that the current embedded memory complies with, and the model of the current embedded memory.

15. The apparatus according to claim 9, wherein the system version corresponding to the partition configuration file includes 4G EMMC version and 16G EMMC version.

16. The apparatus according to claim 9, wherein the reader module is a reading circuit, the determiner module is a comparator, and the selector module is a transmission link establishing circuit; and wherein:
the reading circuit is connected to the board card through an embedded memory interface, and is configured to read the current embedded memory on the board card to obtain embedded memory information;
the comparator is connected with the reading circuit at one end and connected with the transmission link establishing circuit at the other end, and is configured to receive the embedded memory information obtained by the reading circuit, determine the machine type corresponding to the current embedded memory, and transmit a determination result to the transmission link establishing circuit; and
the transmission link establishing circuit is configured to establish a corresponding transmission link according to the determination result to connect the board card of the terminal with an upgrade file memory, and receive the system version for the current embedded memory from the upgrade file memory for upgrading the partition configuration file that matches with the current embedded memory.

17. The apparatus according to claim 9, wherein the embedded memory is any of Embedded Multi Media Card EMMC, Universal Flash Storage UFS and Non-Volatile Memory express NVMe.

18. A terminal comprising the apparatus according to claim 9.

19. The terminal according to claim 18, the apparatus further comprises: an acquirer circuit connected with the determiner module, and configured to acquire a system version for the current embedded memory according to the machine type determined by the determiner module, for upgrading the partition configuration file that matches with the current embedded memory on the board card according to the system version for the current embedded memory.

20. The terminal according to claim 19, wherein the acquirer circuit comprises:
a link sub-circuit configured to obtain a download link for the system version for the current embedded memory according to the machine type; and
a download sub-circuit connected with the link sub-circuit, and configured to download the system version for the current embedded memory from the download link obtained by the link sub-circuit.
